(19) United States
(12) Patent Application Publication
(10) Pub. No.: US 2024/0227057 A9
(43) Pub. Date: Jul. 11, 2024

(54) Welding Head and Welding Method

(71) Applicants: TE Connectivity Solutions GmbH, Schaffhausen (CH); Tyco Electronics (Shanghai) Co., Ltd., Shanghai (CN)

(72) Inventors: Zongjie (Jason) Tao, Shanghai (CN); Dandan (Emily) Zhang, Shanghai (CN); Roberto Francisco-Yi Lu, Bellevue, WA (US)

(73) Assignees: TE Connectivity Solutions GmbH, Schaffhausen (CH); Tyco Electronics (Shanghai) Co., Ltd., Shanghai (CN)

(21) Appl. No.: 18/493,190

(22) Filed: Oct. 24, 2023

(30) Foreign Application Priority Data
Oct. 24, 2022 (CN) 202211301740.X

(51) Int. Cl. B23K 11/11

(52) U.S. Cl. CPC B23K 11/11

(57) ABSTRACT

A welding head includes a first welding head part having a first welding end adapted to contact a welded member, and a second welding head part having a second welding end adapted to contact the welded member. The first welding head part and the second welding head part are arranged side by side in a horizontal direction and are movable relative to each other in a vertical direction. The first and second welding head parts are sized and oriented such that, when welding the welded member, a bottom surface of one of the first welding end or the second welding end abuts a top side of the welded member, and a side surface of the other of the first welding end or the second welding end abuts one side of the welded member.

### CROSS-REFERENCE TO RELATED APPLICATION

This application claims the benefit of Chinese Patent Application No. CN202211301740.X filed on Oct. 24, 2022, in the State Intellectual Property Office of China, the whole disclosure of which is incorporated herein by reference.

### FIELD OF THE INVENTION

The present invention relates to a welding head and a welding method using the same.

### BACKGROUND

In order to solder a wire onto a circuit board, prior art methods typically utilize a monolithic welding head. More specifically, a bottom of the welding head is formed with a V-shaped positioning groove suitable for positioning the wire. The wire can be pre-positioned in the V-shaped positioning groove of the welding head. As a result, the welding head can move the wire to the predetermined welding position on the circuit board and heat the wire, so that the wire is welded to the circuit board. However, the circuit board typically has a raised preset solder point. If the preset solder point is adjacent to the welding position of the wire, it will cause the bottom of the welding head to touch the preset solder point, which will prevent the wire from being soldered.

### SUMMARY

According to an embodiment of the present disclosure, a welding head includes a first welding head part having a first welding end adapted to contact a welded member, and a second welding head part having a second welding end adapted to contact the welded member. The first welding head part and the second welding head part are arranged side by side in a horizontal direction and are movable relative to each other in a vertical direction. The first and second welding head parts are sized and oriented such that, when welding the welded member, a bottom surface of one of the first welding end or the second welding end abuts a top side of the welded member, and a side surface of the other of the first welding end or the second welding end abuts one side of the welded member.

### BRIEF DESCRIPTION OF THE DRAWINGS

The invention will now be described by way of example with reference to the accompanying Figures, of which:

FIG. 1 is an illustrative view of a welding head according to an exemplary embodiment of the present invention, wherein the welding head has not yet come into contact with the welded member; and

FIG. 2 is an illustrative view of a welding head according to an exemplary embodiment of the present invention, wherein the welding head has come into contact with the welded member.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment present invention, a welding head includes a first welding head part which has a first welding end for contacting a welded member, and a second welding head part which has a second welding end for contacting the welded member. The first welding head part and the second welding head part are arranged side by side in a horizontal direction and are movable relative to each other in a vertical direction. When welding the welded member, a bottom surface of one of the first welding end and the second welding end abuts the top side of the welded member, and a side surface of the other of the first welding end and the second welding end abuts one side of the welded member.

According to another embodiment of the present disclosure, a welding method comprises the steps of: 1) providing the above welding head; moving the first welding head part such that the bottom surface of the first welding end is against the top side of the welded member; and 2) moving the second welding head such that the side of the second welding end is against one side of the welded member.

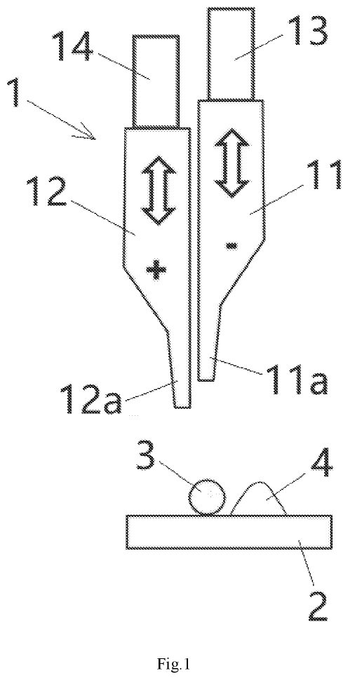

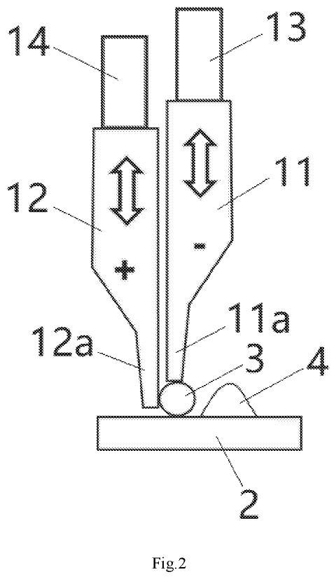

FIG. 1 is an illustrative view of a welding head 1 according to an exemplary embodiment of the present invention, wherein the welding head 1 has not yet come into contact with a welded member 3. FIG. 2 is an illustrative view of a welding head 1 according to an exemplary embodiment of the present invention, wherein the welding head 1 has come into contact with the welded member 3. As shown in FIGS. 1 and 2, in an exemplary embodiment of the present invention, the welding head 1 includes a first welding head part 11 and a second welding head part 12. The first welding head part 11 has a first welding end 11a for contacting the welded member 3. The second welding head part 12 has a second welding end 12a for contacting the welded member 3. The first welding head part 11 and the second welding head part 12 are arranged side by side in a horizontal direction and can be moved relative to each other in a vertical direction.

As shown in FIG. 2, when welding the welded member 3, the bottom surface of one of the first welding end 11a and the second welding end 12a abuts against or contacts the top side of the welded member 3. At the same time, the side surface of the other abuts against or contacts one side of the welded member 3. For example, in the illustrated embodiment, when welding the welded member 3, the bottom surface of the first welding end 11a abuts the top side of the welded member 3, and the side surface of the second welding end 12a abuts one side of the welded member.

In the illustrated embodiment, one of the first welding head part 11 and the second welding head part 12 is used to connect to, or adapted to connect to, a positive pole of a power supply, and the other is used to connect to a negative pole of the power supply. For example, the first welding head part 11 is connected to the negative pole of the power supply, and the second welding head part 12 is connected to the positive pole of the power supply, as shown representatively in FIGS. 1 and 2.

An isolation gap is defined between the first welding head part 11 and the second welding head part 12 to electrically separate the first welding head part from the second welding head part. When welding the welded member 3, the first welding head part 11 and the second welding head part 12 are electrically connected through the welded member to allow current to flow through the first welding head part and the second welding head part.

The welding head 1 further comprises a first actuator 13 and a second actuator 14. The first actuator 13 is connected to the first welding head part 11 and is used to drive the first welding head part to move in the vertical direction. The second actuator 14 is connected to the second welding head part 12 for driving the second welding head part to move in the vertical direction. The welding head 1 also includes a controller electrically connected to the first actuator 13 and the second actuator 14 to control the vertical movement amount of the first actuator and the second actuator.

The welding head 1 is used to solder the welded member 3 to a circuit board 2 with a preset solder point 4 on it. When welding the welded member 3, the bottom surface of the first welding end 11a is pressed against the top side of the welded member, and the side surface of the second welding end 12a is pressed against the side of the welded member opposite to the preset solder point 4 to prevent the welding head 1 from touching the preset solder point. In the exemplary embodiment, the welded member 3 is a wire. When welding the welded member 3, the bottom surface of the first welding end 11a and the bottom surface of the second welding end 12a are staggered by a predetermined distance in the vertical direction, and the predetermined distance is greater than the radius of the wire and smaller than the diameter of the wire.

The first welding head part 11 and the second welding head part 12 may be identical, enabling them to be interchangeably used. This can reduce manufacturing costs. The first welding end 11a and the second welding end 12a are in a pin shape and have a resistance greater than a predetermined value. When welding the welded member 3, the current flows through the first welding end 11a and the second welding end 12a and generates heat to heat the welded member in contact with the first welding end and the second welding end. The first welding end 11a and the second welding end 12a respectively have a flat bottom surface for leaning against the top side of the welded member 3 and a flat side surface for leaning against one side of the welded member.

The first welding head part 11 and the second welding head part 12 can also be moved horizontally relative to each other, so that the horizontal spacing between the two is adjustable according to the horizontal dimension of the welded member 3 in the horizontal direction. In this way, the welding head 1 can be suitable for different sizes of welded members 3, further expanding the application range of welding head. When welding the welded member 3, the horizontal spacing between the first welding head part 11 and the second welding head part 12 is greater than zero and less than the radius of the wire.

In another exemplary embodiment of the present invention, a welding method is al so disclosed. This welding method includes the following steps:
S10: providing the aforementioned welding head 1;
S11: moving the first welding head part 11 in a vertical direction and/or a horizontal direction, so that the bottom surface of the first welding end 11a is against the top side of the welded member 3; and
S12: moving the second welding head part 12 in a vertical direction and/or a horizontal direction, so that the side of the second welding end 12a is against the side of the welded member 3.

The welding method is used to weld the welded member 3 to the circuit board 2. In the aforementioned step S11, the first welding head part 11 applies a predetermined contact pressure on the top side of the welded member 3, causing the welded member to be pressed and fixed on the circuit board 2. As described above, the welded member 3 is a wire, and the circuit board 2 includes the preset solder point 4 adjacent to the welded member. In the previous step S12, the side of the second welding end 12a is pressed against the side of the welded member 3 opposite to the preset solder point 4 to prevent the welding head 1 from touching the preset solder point 4.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A welding head, comprising:
a first welding head part having a first welding end adapted to contact a welded member; and
a second welding head part having a second welding end adapted to contact the welded member, the first welding head part and the second welding head part are arranged side by side in a horizontal direction and are movable relative to each other in a vertical direction.

2. The welding head according to claim 1, wherein the first and second welding head parts are sized and oriented such that, when welding the welded member, a bottom surface of one of the first welding end or the second welding end abuts a top side of the welded member, and a side surface of the other of the first welding end or the second welding end abuts one side of the welded member.

3. The welding head according to claim 2, wherein one of the first welding head part or the second welding head part is connected to a positive pole of a power supply, and the other one of the first welding head part or the second welding head part is connected to a negative pole of the power supply.

4. The welding head according to claim 3, wherein a gap is defined between the first welding head part and the second welding head part to electrically isolate the first welding head part from the second welding head part.

5. The welding head according to claim 3, wherein the first and second welding head parts are sized and oriented such that, when welding the welded member, the first welding head part and the second welding head part are electrically connected through the welded member.

6. The welding head according to claim 3, wherein:
the first welding end and the second welding end define a pin shape and have a resistance greater than a predetermined value; and
when welding the welded member, the welding head is adapted such that current flows through the first welding end and the second welding end and generates heat to heat the welded member in contact with the first welding end and the second welding end.

7. The welding head according to claim 1, further comprising:
a first actuator connected to the first welding head part and driving the first welding head part to move in the vertical direction; and
a second actuator connected to the second welding head part and driving the second welding head part to move in the vertical direction.

8. The welding head according to claim 7, further comprising a controller electrically connected to the first actuator and the second actuator and adapted to control the movement amount of the first actuator and the second actuator in the vertical direction.

9. The welding head according to claim 1, wherein:
the welding head is adapted to solder the welded member to a circuit board having a preset solder point formed thereon; and
when welding the welded member, a bottom surface of one of the first welding end or the second welding end abuts a top side of the welded member, and a side surface of the other one of the first welding end or the second welding end abuts a side of the welded member opposite to the preset solder point to prevent the welding head from touching the preset solder point.

10. The welding head according to claim 9, wherein the welded member is a wire.

11. The welding head according to claim 10, wherein when welding the welded member, the bottom surface of the first welding end and the bottom surface of the second welding end are staggered by a predetermined distance in the vertical direction.

12. The welding head according to claim 11, and the predetermined distance is greater than a radius of the wire and smaller than a diameter of the wire.

13. The welding head according to claim 1, wherein the first welding head part is identical to, and interchangeable with, the second welding head part.

14. The welding head according to claim 1, wherein the first welding end and the second welding end each have a flat bottom surface adapted to abut against a top side of the welded member and a flat side surface adapted to abut one side of the welded member.

15. The welding head according to claim 1, wherein the first welding head part and the second welding head part are movable relative to each other in the horizontal direction, such that a horizontal spacing between the first welding head part and the second welding head part is adjustable according to a horizontal dimension of the welded member in the horizontal direction.

16. The welding head according to claim 15, wherein the welded member is a wire, and when welding the welded member, the horizontal spacing between the first welding head part and the second welding head part is greater than zero and less than a radius of the wire.

17. A welding method comprising steps of:
providing a welding head, including:
a first welding head part having a first welding end adapted to contact a welded member; and
a second welding head part having a second welding end adapted to contact the welded member, the first welding head part and the second welding head part are arranged side by side in a horizontal direction and are movable relative to each other in a vertical direction;
moving the first welding head part so that a bottom surface of the first welding end abuts a top side of the welded member; and
moving the second welding head so that a side of the second welding end abuts one side of the welded member.

18. The welding method according to claim 17, further comprising a step of welding the welded member to a circuit board, wherein during the step of moving the first welding head part, the first welding head applies a predetermined contact pressure on the top side of the welded member and causes the welded member to be pressed and fixed on the circuit board.

19. The welding method according to claim 18, wherein the welded member is a wire and the circuit board has a preset solder point adjacent to the welded member.

20. The welding method according to claim 19, wherein during the step of moving the second welding head part, the side of the second welding end is pressed against the side of the welded member opposite to the preset solder point to prevent the soldering head from touching the preset solder point.
